(19) United States
(12) Patent Application Publication
(10) Pub. No.: US 2007/0083587 A1
(43) Pub. Date: Apr. 12, 2007

(54) Apparatus and method for calculating square root

(75) Inventors: Hee-Jin Roh, Suwon-si (KR); Gang-Mi Gil, Seoul (KR); Min-Goo Kim, Yongin-si (KR); Hyun-Seok Oh, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsumg Electronics Co., Ltd.

(21) Appl. No.: 11/495,632

(22) Filed: Jul. 31, 2006

(30) Foreign Application Priority Data
Jul. 29, 2005 (KR) 2005-69881

(51) Int. Cl. G06F 7/38

(52) U.S. Cl. 708/605

(57) ABSTRACT

An apparatus and method for calculating a square root are provided. The square root calculation apparatus calculates an approximated square root for an input value. An integer detector detects a position of a non-zero most significant bit (MSB) from the input value, and outputs an arbitrary integer value. A first approximated linear square root calculator outputs an approximated square root by applying the input value and an even integer value output from the integer detector to a first linear approximation equation. A second approximated linear square root calculator outputs an approximated square root by applying the input value and an odd integer value output from the integer detector to a second linear approximation equation. A controller controls a multiplexer such that the approximated square roots calculated by the first and second approximated linear square root calculators are output according to whether the integer value output from the integer detector is an even number or an odd number. The multiplexer outputs any one of the approximated square roots output from the first and second approximated linear square root calculators.

### CROSS-REFERENCE TO RELATED APPLICATIONS

This application claims the benefit under 35 U.S.C. § 119(a) of Korean Patent Application No. 2005-69881 filed Jul. 29, 2005 in the Korean Intellectual Property Office, the entire disclosure of which is hereby incorporated by reference.

### BACKGROUND OF THE INVENTION

1. Field of the Invention

The present invention relates generally to an apparatus and method for calculating a square root. In particular, the present invention relates to an apparatus and method for calculating a square root for an input signal.

2. Description of the Related Art

Generally, a number whose square is ‘a’ is called a square root of ‘a’. For a real number ‘a’ and a natural number ‘n’, if there is ‘x’ satisfying xⁿ=a, it is called an n^{th} root of ‘a’, and for n=2, it is called a square root. For a positive real number ‘a’, an n^{th} root of ‘a’ is denoted by ⁿ\sqrt{a}. The symbol √ is called a radical sign or a root, and a natural number ‘n’ written on the left top of the root is called an index of the root. For a square root, the index of root is omitted. In addition, as to a range of a square root of ‘a’ for a>0, there is a positive and a negative number having the same absolute value. Of the two numbers, the positive one is denoted by \sqrt{a} and the negative one is denoted by −\sqrt{a}. That is, a square root of ‘a’ is±\sqrt{a}. For a=0, a square root of ‘a’ is ‘0’. For a<0, there are two square roots of ‘a’, but both are imaginary numbers. Generally, because \sqrt{a}≧0 for a ≧0, Equation (1) below is given for an arbitrary real number ‘a’.

$$\sqrt{{a}^{2}} = \vert a \vert = \{ \begin{matrix}a & ( for a \geq 0 ) \\ - a & ( for a < 0 )\end{matrix} \qquad ( 1 )$$

A square root calculation apparatus for calculating the square root is an apparatus frequently used in a very wide range of operations during implementation of hardware logics. For example, the square root calculation apparatus is applied (i) when there is a need for square root calculation not only in a mobile communication system but also in a digital system, (ii) when a mobile station desires to calculate a level of a received signal from a power value of the received signal, and (iii) when the mobile station calculates a standard deviation from various variances.

The conventional square root calculation schemes are classified into two types.

A first square root calculation scheme, a scheme using a look-up table, determines a range of an input value ‘x’, stores a square root for the ‘x’ in the range in the look-up table, and outputs the stored value when necessary.

This scheme uses a Read Only Memory (ROM) table in which the number of bits of an input value is defined as an address, and outputs previously stored square root values.

However, in the square root calculation scheme using the look-up table, an increase in the number of bits of an input value causes an exponential increase in size of the ROM that stores the square root values. This is because when the number of input bits increases by 1, the ROM size is doubled. For example, if the number of input bits is defined as ‘m’ and the number of output bits is defined as ‘n’, a memory for storing the square roots needs a size of 2^{m}×n bits. Therefore, for an input value having a wide range, it is difficult to use the square root calculation scheme using the look-up table.

A second square root calculation scheme calculates a square root using iteration. That is, this scheme iteratively performs addition and subtraction to reduce an error between an input value ‘x’ and an output value ‘y’ so that the output value ‘y’ approximates an actual square root value.

However, the square root calculation scheme using iteration, as it iteratively performs addition and subtraction, can be hardly used when there is a need for fast calculation.

In addition, in calculating a square root using the iteration-based square root calculation scheme, it is possible to output a value more closely approximating the square root as iteration on the input value increases in number. However, the increase in the iteration increases the power consumption.

Accordingly, there is a need for an improved apparatus and method for calculating a square root.

### SUMMARY OF THE INVENTION

Exemplary embodiments of the present invention address at least the above problems and/or disadvantages and provide at least the advantages described below. It is, therefore, an object of the present invention to provide a square root calculation apparatus and method for calculating an approximated value of a square root.

It is another object of the present invention to provide a square root calculation apparatus and method capable of performing fast square root calculation without using a separate memory.

It is further another object of the present invention to provide a square root calculation apparatus and method for calculating an approximated square root with reduced calculation, thereby reducing power consumption.

According to one exemplary aspect of the present invention, there is provided a square root calculation apparatus for calculating an approximated square root for an input value. The apparatus comprises an integer detector for detecting a position of a non-zero most significant bit (MSB) from the input value, and outputting an arbitrary integer value, a first approximated linear square root calculator for outputting an approximated square root by applying the input value and an even integer value output from the integer detector to a first linear approximation equation, a second approximated linear square root calculator for outputting an approximated square root by applying the input value and an odd integer value output from the integer detector to a second linear approximation equation, a controller for controlling a multiplexer such that the approximated square roots calculated by the first and second approximated linear square root calculators are output according to whether the integer value output from the integer detector is an even number or an odd number, wherein the multiplexer outputs any one of the approximated square roots output from the first and second approximated linear square root calculators under the control of the controller.

According to another exemplary aspect of the present invention, there is provided a square root calculation method for calculating an approximated square root for an input value. The method comprises determining a position of a non-zero most significant bit (MSB) from the input value, and outputting an arbitrary integer value, outputting a first approximated square root by applying the input value and an even integer value among the arbitrary integer values to a first linear approximation equation, outputting a second approximated square root by applying the input value and an odd integer value among the arbitrary integer values to a second linear approximation equation and outputting any one of the first and second approximated square roots.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a structure of a square root calculation apparatus according to an exemplary embodiment of the present invention;

FIG. 2 is a graph for describing of a linear approximation scheme applied as an exemplary embodiment of the present invention;

FIG. 3 is a detailed block diagram illustrating a structure of an exemplary integer detector;

FIG. 4 is a flowchart illustrating a method for calculating a square root in a square root calculation apparatus according to an exemplary embodiment of the present invention;

FIG. 5A is a block diagram illustrating a structure of a square root calculation apparatus for m=even according to an exemplary embodiment of the present invention;

FIG. 5B is a block diagram illustrating a structure of a square root calculation apparatus for m=odd according to an exemplary embodiment of the present invention;

FIG. 6 is a block diagram illustrating a structure of a square root calculation apparatus according to another exemplary embodiment of the present invention, in which it is assumed that the finite number of bits of an input value ‘x’ is 13;

FIG. 7 is a graph illustrating a difference between an actual square root and a square root calculated by the square root calculation scheme proposed by an exemplary embodiment of the present invention;

FIG. 8 is a graph illustrating a square of a normalized squared error between an actual square root and a square root calculated by the square root calculation scheme proposed by an exemplary embodiment of the present invention; and

FIG. 9 is a diagram illustrating a characteristic curve of a floor(z) function and a ceil(z) function according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will now be described in detail with reference to the annexed drawings.

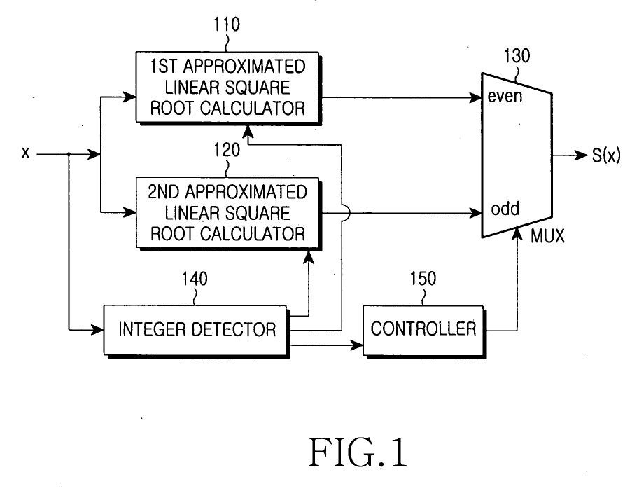

FIG. 1 is a block diagram illustrating a structure of a square root calculation apparatus according to an exemplary embodiment of the present invention. With reference to FIG. 1, a description will now be made of an operation of the square root calculation apparatus.

An input value ‘x’ is applied to a first approximated linear square root calculator 110, a second approximated linear square root calculator 120, and an integer detector 140.

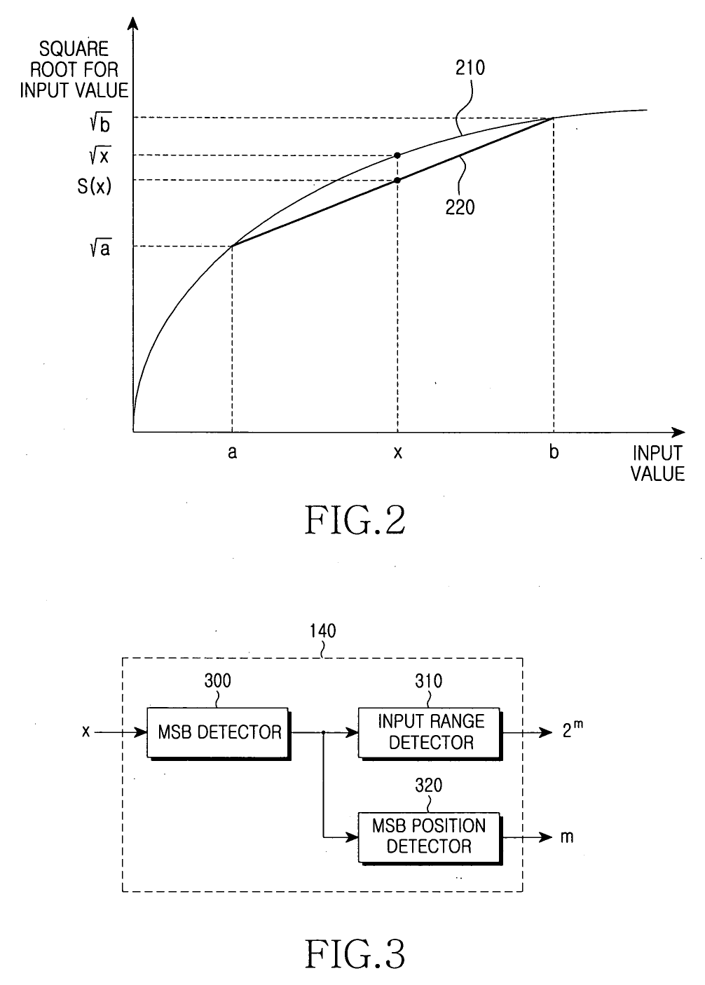

Each of the first approximated linear square root calculator 110 and the second approximated linear square root calculator 120 calculates an approximated square root for an input value ‘x’ using a linear approximation scheme. The linear approximation scheme will be described with reference to FIG. 2. FIG. 2 is a graph for a description of a linear approximation scheme applied to the present invention.

Referring to FIG. 2, to calculate an approximated square root for an input value ‘x’, the linear approximation scheme first finds ‘a’ which is less than or equal to ‘x’, and ‘b’ which is greater than ‘x’. Then, because a square root of ‘x’ is a monotone increasing function represented by reference numeral 210, an approximated square root of ‘x’ exists between a square root of ‘a’ and a square root of ‘b’ as shown by reference numeral 220, and can be calculated using the linear approximation scheme in accordance with Equation (2) below.

$$S ( x ) = \frac{x - a}{b - a} \cdot ( \sqrt{b} - \sqrt{a} ) + \sqrt{a} \approx \sqrt{x} \qquad ( 2 )$$

In the exemplary embodiment, a power of 2 is used as values of ‘a’ and ‘b’. That is, to calculate an approximated square root for the input value ‘x’, the linear approximation scheme finds an integer ‘m’ satisfying 2^{m}≦x<2^{m+1} (for m≧0) so that a=2^{m} and b=2^{m+1}. The integer ‘m’ is determined by the integer detector 140.

The value ‘m’ determined by the integer detector 140 is input to the first approximated linear square root calculator 110 and the second approximated linear square root calculator 120.

An operation of determining the value ‘m’ in the integer detector 140 will be described with reference to FIG. 3. FIG. 3 is a detailed block diagram illustrating an exemplary structure of an integer detector.

If an input value ‘x’ is applied to a non-zero Most Significant Bit (MSB) detector 300, the non-zero MSB detector 300 determines a non-zero MSB value of the input value ‘x’. The output value of the non-zero MSB detector 300 is branched to an input range detector 310 and a non-zero MSB position detector 320. For example, for an input value x=‘0b00010101’, a non-zero MSB value of the input value ‘x’ is ‘1’ located immediately after the bits ‘0b000’. The non-zero MSB detector 300 determines a value of ‘1’.

The input range detector 310 outputs 2^{m}. That is, the input range detector 310 sets all bits except for the MSB ‘1’ determined by the non-zero MSB detector 300 to ‘0’, and outputs 2^{m}. For example, the input range detector 310 generates ‘0b00010000’ and outputs 2^{m}.

The non-zero MSB position detector 320 outputs ‘m’. That is, the non-zero MSB position detector 320 determines a position of a non-zero MSB of the input value ‘x’, and outputs a value ‘m’. For example, in ‘0b00010000’, MSB is ‘1’ and a position of ‘1’ is 5. Therefore, the value ‘m’ is 5.

Therefore, a linear approximation equation of a square root, shown in Equation (3), can be obtained by substituting a=2^{m} and b=2^{m+1} in Equation (2).

$$\begin{matrix}S ( x ) = \frac{x - {2}^{m}}{{2}^{m}} \cdot ( \sqrt{{2}^{m + 1}} - \sqrt{{2}^{m}} ) + \sqrt{{2}^{m}} \\ = \frac{x}{{2}^{m / 2}} \cdot ( \sqrt{2} - 1 ) + {2}^{m / 2} \cdot ( 2 - \sqrt{2} )\end{matrix} \qquad ( 3 )$$

However, if Equation (3) is implemented, for m=odd, the 2^{m/2} calculation is not a simple bit shift operation and \sqrt{2} should be additionally processed, thus increasing complexity.

Therefore, in order to simply implement the calculation in Equation (3), it is possible to calculate the approximated square root separately for m=odd and m=even.

The equations separately calculated for m=odd and m=even can be changed to Equation (4) and Equation (5) including only the bit shift operation. In Equation (4), m is defined as 2q, and in Equation (5), m is defined as 2q+1. In addition, q is defined as an integer greater than 0.

$$\begin{matrix}\begin{matrix}S ( x ) = \frac{x}{{2}^{m / 2}} \cdot ( \sqrt{2} - 1 ) + {2}^{m / 2} ( 2 - \sqrt{2} ) \\ = \frac{x}{{2}^{q}} \cdot ( \sqrt{2} - 1 ) + {2}^{q} ( 2 - \sqrt{2} )\end{matrix} & ( 4 ) \\ \begin{matrix}S ( x ) = \frac{x}{{2}^{( m + 1 ) / 2}} \cdot ( 2 - \sqrt{2} ) + {2}^{( m + 1 ) / 2} ( \sqrt{2} - 1 ) \\ = \frac{x}{{2}^{( q + 1 )}} \cdot ( 2 - \sqrt{2} ) + {2}^{( q + 1 )} ( \sqrt{2} - 1 )\end{matrix} & ( 5 )\end{matrix}$$

The first approximated linear square root calculator 110 and the second approximated linear square root calculator 120 perform the calculations of Equation (4) and Equation (5), respectively, and then output the results to a multiplexer (MUX) 130.

A controller 150 determines whether the output value ‘m’ of the integer detector 140 is an odd number or an even number. If the value ‘m’ is an even number, the controller 150 controls the MUX 130 to output the value calculated by the first approximated linear square root calculator 110.

However, if the output value ‘m’ of the integer detector 140 is an odd number, the controller 150 controls the MUX 130 to output the value calculated by the second approximated linear square root calculator 120.

The MUX 130, under the control of the controller 150, outputs the value calculated by the first approximated linear square root calculator 110 or the second approximated linear square root calculator 120.

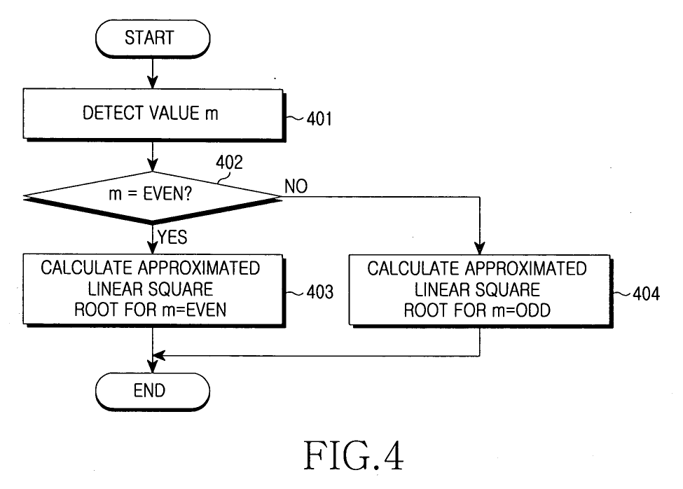

A square root calculation operation in the exemplary square root calculation apparatus will now be described with reference to a flowchart of FIG. 4. FIG. 4 is a flowchart illustrating a method for calculating a square root in a square root calculation apparatus according to an embodiment of the present invention.

In step 401, the integer detector 140 determines a value ‘m’. Then, in step 402, the controller 150 determines whether the value ‘m’ determined by the integer detector 140 is an even number. If the value ‘m’ is an even number, the controller 150 controls, in step 403, the MUX 130 to output the value calculated by the first approximated linear square root calculator 110. Herein, the first approximated linear square root calculator 110 calculates Equation (4).

However, if the value ‘m’ is an odd number, the controller 150 controls, in step 404, the MUX 130 to output the value calculated by the second approximated linear square root calculator 120. Herein, the second approximated linear square root calculator 120 calculates Equation (5).

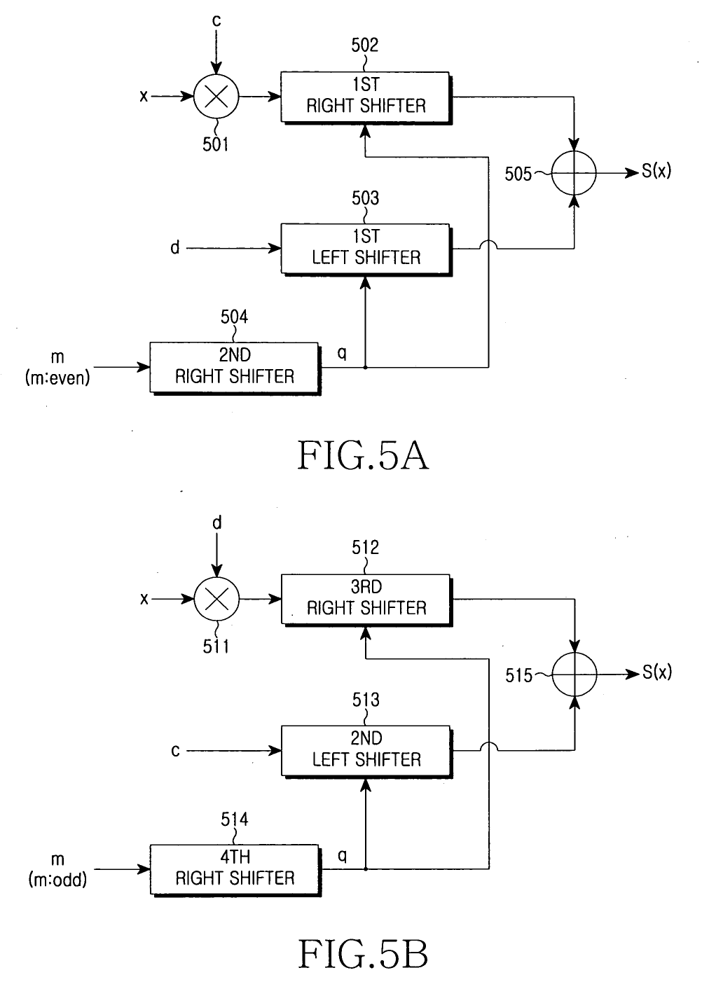

Calculations of constants 2−\sqrt{2} and \sqrt{2}−1 in Equation (4) and Equation (5) are complex because of the calculation of \sqrt{2}. In order to simply perform the complex calculations, exemplary square root calculation apparatuses of FIGS. 5A and 5B are proposed. FIG. 5A is a block diagram illustrating a structure of a square root calculation apparatus for m=even according to an exemplary embodiment of the present invention, and FIG. 5B is a block diagram illustrating a structure of a square root calculation apparatus for m=odd according to an exemplary embodiment of the present invention.

In Equation (4) and Equation (5), \sqrt{2}−1 is defined as ‘c’ and 2−\sqrt{2} is defined as ‘d’.

Referring to FIG. 5A, an even value ‘m’ is input to a second right shifter 504. Then the second right shifter 504 right-shifts the input ‘m’ by 1 bit. That is, the second right shifter 504 divides the input ‘m’ by 2, and outputs ‘q’. The output ‘q’ is input to a first right shifter 502 and a first left shifter 503.

A first multiplier 501 multiplies an input value ‘x’ by ‘c’, and outputs the result to the first right shifter 502. The first right shifter 502 right-shifts its value by q bits upon receipt of the output ‘q’ of the second right shifter 504 and the product of the input value ‘x’ and ‘c’. That is, the first right shifter 502 divides its value by 2^{q}, and outputs the result to a first adder 505.

Upon receipt of a value ‘d’ and the output ‘q’ of the second right shifter 504, the first left shifter 503 left-shifts its value by q bits. That is, the first left shifter 503 multiplies ‘d’ and ‘q’ by 2^{q}, and outputs the result to the first adder 505. As a result, the first adder 505 can calculate a value S(x) for m=even by adding up the output value of the first right shifter 502 and the output value of the first left shifter 503.

Referring to FIG. 5B, an odd value ‘m’ is input to a fourth right shifter 514. Then the fourth right shifter 514 right-shifts the input ‘m’ by 1 bit. That is, the fourth right shifter 514 divides the odd input ‘m’ by 2, and outputs ‘q’. The output ‘q’ is input to a third right shifter 512 and a second left shifter 513.

A second multiplier 511 multiplies the input value ‘x’ by ‘d’, and outputs the result to the third right shifter 512. The third right shifter 512 right-shifts its value by q+1 bits upon receipt of the output ‘q’ of the fourth right shifter 514 and the product of the input value ‘x’ and ‘d’. That is, the third right shifter 512 divides its value by 2^{q+1}, and outputs the result to a second adder 515.

Upon receipt of a value ‘c’ and the output ‘q’ of the fourth right shifter 514, the second left shifter 513 left-shifts its value by q+1 bits. That is, the second left shifter 513 multiplies ‘c’ and ‘q’ by 2^{q+1}, and outputs the result to the second adder 515. As a result, the second adder 515 can calculate a value S(x) for m=odd by adding up the output value of the third right shifter 512 and the output value of the second left shifter 513.

The square root calculation apparatuses of FIGS. 5A and 5B each need one multiplication by the input value ‘x’, three bit-shift operations, and one addition, and can be designed using simple logic.

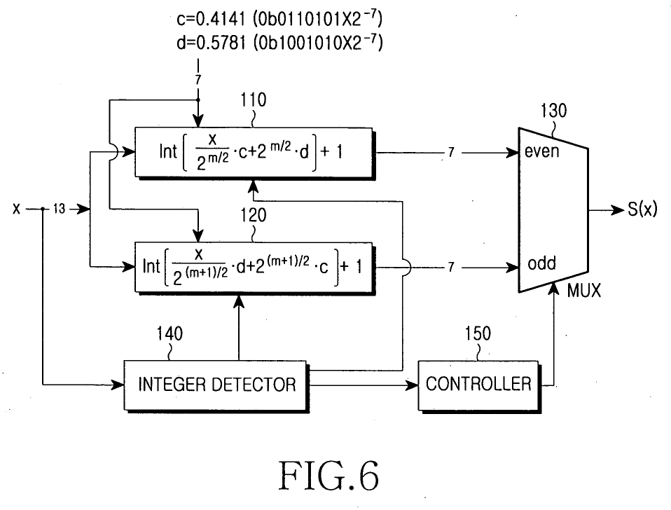

A square root calculation apparatus according to another exemplary embodiment of the present invention is illustrated in FIG. 6. FIG. 6 is a block diagram illustrating a structure of a square root calculation apparatus according to another exemplary embodiment of the present invention, in which it is assumed that the finite number of bits of an input value ‘x’ is 13.

If 13 finite bits of the input value ‘x’ are input to the square root calculation apparatus, the 13 finite bits are input to a first approximated linear square root calculator 110, a second approximated linear square root calculator 120, and an integer detector 140.

A value ‘m’ determined by the integer detector 140 is input to the first approximated linear square root calculator 110 and the second approximated linear square root calculator 120.

The first approximated linear square root calculator 110 performs calculation of Equation (6) below, and the second approximated linear square root calculator 120 performs calculation of Equation (7) below.

Equation (6) is modified from Equation (4) such that \sqrt{2}−1 is defined as ‘c’, 2−\sqrt{2} is defined as ‘d, a finite number of bits are provided, and an integer is taken for S(x) so that only the integer is output.

Similarly, Equation (7) is modified from Equation (5) such that \sqrt{2}−1 is defined as ‘c’, 2−∞\sqrt{2} is defined as ‘d, a finite number of bits are provided, and an integer is taken for S(x) so that only the integer is output.

$$\begin{matrix}{S}_{I} ( x ) = Int ( \frac{x}{{2}^{q}} \cdot c + {2}^{q} \cdot d ) + p & ( 6 ) \\ {S}_{I} ( x ) = Int ( \frac{x}{{2}^{( q + 1 )}} \cdot d + {2}^{( q + 1 )} \cdot c ) + p & ( 7 )\end{matrix}$$

In FIG. 6, for ‘c’ and ‘d’, 7 effective bits of 0110101 and 1001010 are used, respectively, like 0b0110101×2⁻⁷ and 0b1001010×2⁻⁷.

In addition, both the first approximated linear square root calculator 110 and the second approximated linear square root calculator 120 use p=1. In Equation (6) and Equation (7), adding the constant p in the last term is to reduce an error between an actual square root and a square root calculated by the square root calculation scheme proposed by an exemplary embodiment of the present invention. Further, in Equation (6) and Equation (7), if an input value is ‘0’ regardless of a value of the ‘p’, S(x) or S_{I}(x) is output as ‘0’.

A controller 150 determines whether the output value ‘m’ of the integer detector 140 is an odd number or an even number. If the value ‘m’ is an even number, the controller 150 controls a MUX 130 to output the 7-bit value calculated by the first approximated linear square root calculator 110 in accordance with Equation (6).

However, if the value ‘m’ is an odd number, the controller 150 controls the MUX 130 to output the 7-bit value calculated by the second approximated linear square root calculator 120 in accordance with Equation (7).

The MUX 130, under the control of the controller 150, outputs the value calculated by the first approximated linear square root calculator 110 or the second approximated linear square root calculator 120.

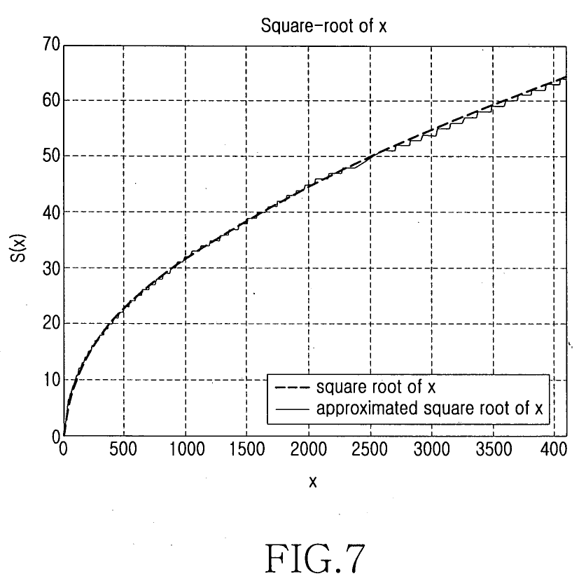

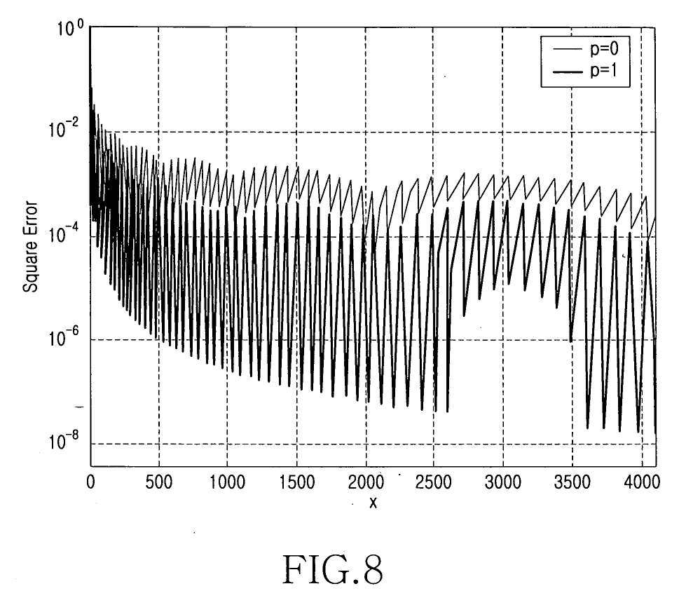

FIG. 7 is a graph illustrating a difference between an actual square root and a square root calculated by the square root calculation scheme proposed by an exemplary embodiment of the present invention.

The square root calculation scheme of FIG. 6 corresponds to the case where p=1 in Equation (6) and Equation (7), and it can be noted from FIG. 7 that there is a slight difference between the actual square root and the square root calculated by the square root calculation scheme of FIG. 6. To quantize this, a normalized squared error between the actual square root and the square root calculated by the proposed scheme is defined as

$$SE ( x ) = {( \frac{{S}_{I} ( x ) - \sqrt{x}}{\sqrt{x}} )}^{2} \qquad ( 8 )$$

FIG. 8 is a graph illustrating a square of a normalized squared error between an actual square root and a square root calculated by the square root calculation scheme proposed by an exemplary embodiment of the present invention.

FIG. 8 graphically shows Equation (8) for an input value ‘x’ separately for p=0 and p=1. Herein, p=0 defines an action of discarding digits below the decimal, and p=1 defines an action of discarding digits below the decimal and then adding 1 thereto.

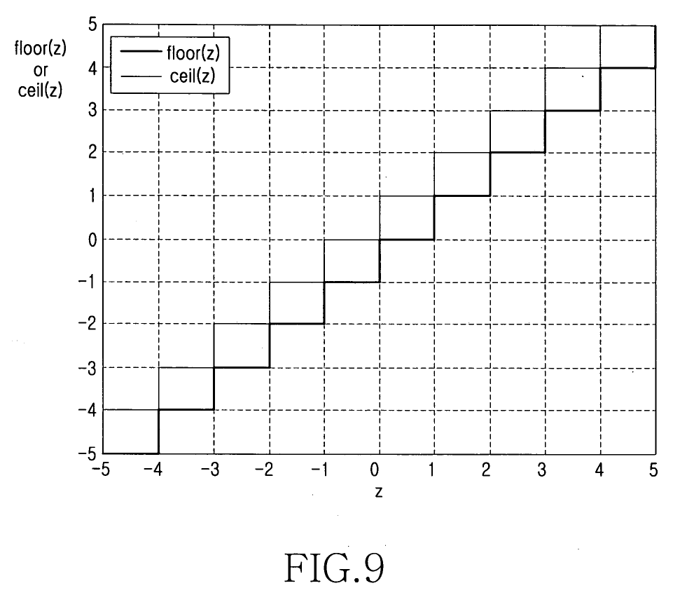

It can be noted from FIG. 8 that compared with the calculated square root for p=0, the calculated square root for p=1 is closer to the actual square root. That is, the use of p=1 decreases an error, contributing to an increase in efficiency. Herein, p=0 and p=1 indicate that p=0 for floor(S(x)) and p=1 for ceil(S(x)) as shown in FIG. 9, respectively. FIG. 9 is a diagram illustrating a characteristic curve of a floor(z) function and a ceil(z) function according to an exemplary embodiment of the present invention.

Additionally, in implementing the foregoing exemplary embodiment of the present invention, for m=even, only the first approximated linear square root calculator 110 is enabled and the second approximated linear square root calculator 120 is disabled, reducing power consumption. Similarly, for m=odd, only the second approximated linear square root calculator 120 is enabled and the first approximated linear square root calculator 110 is disabled, reducing power consumption.

As described with reference to FIGS. 7 and 8, it can be appreciated that the difference between the actual square root and the square root calculated by the square root calculation scheme proposed by exemplary embodiments of the present invention is very slight. Therefore, the square root calculated by the square root calculation scheme proposed by exemplary embodiments of the present invention can be used as an approximated value of the actual square root. In addition, the square root calculation scheme proposed by exemplary embodiments of the present invention need one multiplication, one addition, and three bit-shift operations for square root calculation, thereby reducing the hardware complexity and facilitating fast square root calculation. Moreover, because the proposed square root calculation scheme does not need a separate storage space, it can be applied when there is a need for square root calculation in hardware implementation.

Exemplary embodiments of the present invention have the following advantages.
Exemplary embodiments of the present invention can calculate an approximate value of a square root without complex calculations.
Exemplary embodiments of the present invention need one multiplication, one addition, and three bit-shift operations for square root calculation, contributing to a reduction in the hardware complexity.
Exemplary embodiments of the present invention can perform fast square root calculation without using a separate memory.
For m=even, exemplary embodiments of the present invention enable only the first approximated linear square root calculator and disable the second approximated linear square root calculator, thereby reducing power consumption.
For m=odd, exemplary embodiments of the present invention enable only the second approximated linear square root calculator and disable the first approximated linear square root calculator, thereby reducing power consumption.

Certain exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains

While the invention has been shown and described with reference to a certain exemplary embodiments thereof, it will be understood by those skilled in the art that various changes in form and details may be made therein without departing from the spirit and scope of the invention as defined by the appended claims and the full scope of equivalents thereof.

What is claimed is:

1. A square root calculation apparatus for calculating an approximated square root for an input value, the apparatus comprising:
an integer detector for determining a position of a non-zero most significant bit (MSB) from an input value, and outputting an integer value;
a first approximated linear square root calculator for outputting an approximated square root by applying the input value and an even integer value output from the integer detector to a first linear approximation equation;
a second approximated linear square root calculator for outputting an approximated square root by applying the input value and an odd integer value output from the integer detector to a second linear approximation equation;
a multiplexer for outputting either of the approximated square roots output from the first and second approximated linear square root calculators; and
a controller for controlling the multiplexer such that the approximated square roots calculated by the first and second approximated linear square root calculators are output according to whether the integer value output from the integer detector is an even number or an odd number.

2. The square root calculation apparatus of claim 1, wherein if the integer value output from the integer detector is an even number, the controller controls the multiplexer such that the approximated square root calculated by the first approximated linear square root calculator is output.

3. The square root calculation apparatus of claim 1, wherein if the integer value output from the integer detector is an odd number, the controller controls the multiplexer such that the approximated square root calculated by the second approximated linear square root calculator is output.

4. The square root calculation apparatus of claim 1, wherein the integer detector determines an integer ‘m’ satisfying the relation of
2^{m}≦x<2^{m+1}
where ‘x’ denotes the input value.

5. The square root calculation apparatus of claim 4, wherein the integer detector comprises:
an MSB detector for determining a non-zero MSB from the input value;
an input range detector for setting all bits except for the determined MSB to ‘0’, and outputting 2^{m}; and
an MSB position detector for determining a position of a non-zero MSB from the determined MSB, and outputting the integer value ‘m’.

6. The square root calculation apparatus of claim 1, wherein the first linear approximation equation is expressed as
$$\begin{matrix}S ( x ) = \frac{x}{{2}^{m / 2}} \cdot ( \sqrt{2} - 1 ) + {2}^{m / 2} ( 2 - \sqrt{2} ) \\ = \frac{x}{{2}^{q}} \cdot ( \sqrt{2} - 1 ) + {2}^{q} ( 2 - \sqrt{2} )\end{matrix}$$
where ‘m’ is defined as 2q, and ‘q’ is defined as an integer greater than or equal to ‘0’.

7. The square root calculation apparatus of claim 1, wherein the second linear approximation equation is expressed as
$$\begin{matrix}S ( x ) = \frac{x}{{2}^{( m + 1 ) / 2}} \cdot ( 2 - \sqrt{2} ) + {2}^{( m + 1 ) / 2} ( \sqrt{2} - 1 ) \\ = \frac{x}{{2}^{( q + 1 )}} \cdot ( 2 - \sqrt{2} ) + {2}^{( q + 1 )} ( \sqrt{2} - 1 )\end{matrix}$$
where ‘m’ is defined as 2q+1, and ‘q’ is defined as an integer greater than or equal to ‘0’.

8. The square root calculation apparatus of claim 6, wherein if S(x) is expressed such that it has a finite number of bits, it is calculated by
$${S}_{I} ( x ) = Int ( \frac{x}{{2}^{q}} \cdot c + {2}^{q} \cdot d ) + p$$
where S_{I}(x) denotes an integer taken from S(x), ‘c’ is defined as \sqrt{2}−1, and ‘d’ is defined as 2−\sqrt{2}.

9. The square root calculation apparatus of claim 7, wherein if S(x) is expressed such that it has a finite number of bits, it is calculated by
$${S}_{I} ( x ) = Int ( \frac{x}{{2}^{( q + 1 )}} \cdot d + {2}^{( q + 1 )} \cdot c ) + p$$
where Si(x) denotes an integer taken from S(x), ‘c’ is defined as \sqrt{2}−1, and ‘d’ is defined as 2−\sqrt{2}.

10. The square root calculation apparatus of claim 8, wherein ‘p’ is added to reduce an error between S_{I}(x) and an actual square root of the input value.

11. The square root calculation apparatus of claim 9, wherein ‘p’ is added to reduce an error between S_{I}(x) and an actual square root of the input value.

12. The square root calculation apparatus of claim 8, wherein a square of a normalized squared error between S_{I}(x) and an actual square root of the input value is defined as
$$SE ( x ) = {( \frac{{S}_{I} ( x ) - \sqrt{x}}{\sqrt{x}} )}^{2} .$$

13. The square root calculation apparatus of claim 9, wherein a square of a normalized squared error between S_{I}(x) and an actual square root of the input value is defined as
$$SE ( x ) = {( \frac{{S}_{I} ( x ) - \sqrt{x}}{\sqrt{x}} )}^{2} .$$

14. A square root calculation method for calculating an approximated square root of an input value, the method comprising:
determining a position of a non-zero most significant bit (MSB) from an input value, and outputting an integer value;
outputting a first approximated square root by applying the input value and an even integer value among the integer values to a first linear approximation equation;
outputting a second approximated square root by applying the input value and an odd integer value among the integer values to a second linear approximation equation; and
outputting any one of the first and second approximated square roots.

15. The square root calculation method of claim 14, wherein outputting an integer value comprises determining an integer ‘m’ satisfying the relation of
2^{m}≦x<2^{m+1}
where ‘x’ denotes the input value.

16. The square root calculation method of claim 15, wherein outputting an integer value comprises:
determining a non-zero MSB from the input value;
setting all bits except for the determined MSB to ‘0’, and outputting 2m; and
determining a position of a non-zero MSB from the determined MSB, and outputting the integer value ‘m’.

17. The square root calculation method of claim 14, wherein the first linear approximation equation is expressed as
$$\begin{matrix}S ( x ) = \frac{x}{{2}^{m / 2}} \cdot ( \sqrt{2} - 1 ) + {2}^{m / 2} ( 2 - \sqrt{2} ) \\ = \frac{x}{{2}^{q}} \cdot ( \sqrt{2} - 1 ) + {2}^{q} ( 2 - \sqrt{2} )\end{matrix}$$
where ‘m’ is defined as 2q, and ‘q’ is defined as an integer greater than or equal to ‘0’.

18. The square root calculation method of claim 14, wherein the second linear approximation equation is expressed as
$$\begin{matrix}S ( x ) = \frac{x}{{2}^{( m + 1 ) / 2}} \cdot ( 2 - \sqrt{2} ) + {2}^{( m + 1 ) / 2} ( \sqrt{2} - 1 ) \\ = \frac{x}{{2}^{( q + 1 )}} \cdot ( 2 - \sqrt{2} ) + {2}^{( q + 1 )} ( \sqrt{2} - 1 )\end{matrix}$$
where ‘m’ is defined as 2q+1, and ‘q’ is defined as an integer greater than or equal to ‘0’.

19. The square root calculation method of claim 17, wherein if S(x) is expressed such that it has a finite number of bits, it is calculated by
$${S}_{I} ( x ) = Int ( \frac{x}{{2}^{q}} \cdot c + {2}^{q} \cdot d ) + p$$
where S_{I}(x) denotes an integer taken from S(x), ‘c’ is defined as \sqrt{2}−1, and ‘d’ is defined as 2−\sqrt{2}.

20. The square root calculation method of claim 18, wherein if S(x) is expressed such that it has a finite number of bits, it is calculated by
$${S}_{I} ( x ) = Int ( \frac{x}{{2}^{( q + 1 )}} \cdot d + {2}^{( q + 1 )} \cdot c ) + p$$
where S_{I}(x) denotes an integer taken from S(x), ‘c’ is defined as \sqrt{2}−1, and ‘d’ is defined as 2−\sqrt{2}.

21. The square root calculation method of claim 19, wherein ‘p’ is added to reduce an error between S_{I}(x) and an actual square root of the input value.

22. The square root calculation method of claim 20, wherein ‘p’ is added to reduce an error between the S_{I}(x) and an actual square root of the input value.

23. The square root calculation method of claim 19, wherein a square of a normalized squared error between S_{I}(x) and an actual square root of the input value is defined as
$$SE ( x ) = {( \frac{{S}_{I} ( x ) - \sqrt{x}}{\sqrt{x}} )}^{2} .$$

24. The square root calculation method of claim 20, wherein a square of a normalized squared error between S_{I}(x) and an actual square root of the input value is defined as
$$SE ( x ) = {( \frac{{S}_{I} ( x ) - \sqrt{x}}{\sqrt{x}} )}^{2} .$$

25. A computer-readable medium having stored thereon instructions for executing a method of calculating an approximated square root of an input value, the instructions comprising:
a first set of instructions for determining a position of a non-zero most significant bit (MSB) from an input value, and outputting an integer value;
a second set of instructions for outputting a first approximated square root by applying the input value and an even integer value among the integer values to a first linear approximation equation;
a third set of instructions for outputting a second approximated square root by applying the input value and an odd integer value among the integer values to a second linear approximation equation; and
a fourth set of instructions for outputting any one of the first and second approximated square roots.

26. The computer-readable medium of claim 25, wherein outputting an integer value comprise determining an integer ‘m’ satisfying the relation of
2^{m}≦x<2^{m+1}
where ‘x’ denotes the input value.

27. The computer-readable medium of claim 26, wherein outputting an integer value comprises:
determining a non-zero MSB from the input value;
setting all bits except for the determined MSB to ‘0’, and outputting 2m; and
determining a position of a non-zero MSB from the determined MSB, and outputting the integer value ‘m’.

28. The computer-readable medium of claim 25, wherein the first linear approximation equation is expressed as
$$\begin{matrix}S ( x ) = \frac{x}{{2}^{m / 2}} \cdot ( \sqrt{2} - 1 ) + {2}^{m / 2} ( 2 - \sqrt{2} ) \\ = \frac{x}{{2}^{q}} \cdot ( \sqrt{2} - 1 ) + {2}^{q} ( 2 - \sqrt{2} )\end{matrix}$$
where ‘m’ is defined as 2q, and ‘q’ is defined as an integer greater than or equal to ‘0’.

29. The computer-readable medium of claim 25, wherein the second linear approximation equation is expressed as
$$\begin{matrix}S ( x ) = \frac{x}{{2}^{( m + 1 ) / 2}} \cdot ( 2 - \sqrt{2} ) + {2}^{( m + 1 ) / 2} ( \sqrt{2} - 1 ) \\ = \frac{x}{{2}^{( q + 1 )}} \cdot ( 2 - \sqrt{2} ) + {2}^{( q + 1 )} ( \sqrt{2} - 1 )\end{matrix}$$
where ‘m’ is defined as 2q+1, and ‘q’ is defined as an integer greater than or equal to ‘0’.

30. The computer-readable medium of claim 28, wherein if S(x) is expressed such that it has a finite number of bits, it is calculated by
$${S}_{I} ( x ) = Int ( \frac{x}{{2}^{q}} \cdot c + {2}^{q} \cdot d ) + p$$
where S_{I}(x) denotes an integer taken from S(x), ‘c’ is defined as \sqrt{2}−1, and ‘d’ is defined as 2−\sqrt{2}.

31. The computer-readable medium of claim 29, wherein if S(x) is expressed such that it has a finite number of bits, it is calculated by
$${S}_{I} ( x ) = Int ( \frac{x}{{2}^{( q + 1 )}} \cdot d + {2}^{( q + 1 )} \cdot c ) + p$$
where S_{I}(x) denotes an integer taken from S(x), ‘c’ is defined as \sqrt{2}−1, and ‘d’ is defined as 2−\sqrt{2}.

32. The computer-readable medium of claim 30, wherein ‘p’ is added to reduce an error between S_{I}(x) and an actual square root of the input value.

33. The computer-readable medium of claim 31, wherein ‘p’ is added to reduce an error between the S_{I}(x) and an actual square root of the input value.

34. The computer-readable medium of claim 30, wherein a square of a normalized squared error between S_{I}(x) and an actual square root of the input value is defined as
$$SE ( x ) = {( \frac{{S}_{I} ( x ) - \sqrt{x}}{\sqrt{x}} )}^{2} .$$

35. The computer-readable medium of claim 31, wherein a square of a normalized squared error between S_{I}(x) and an actual square root of the input value is defined as
$$SE ( x ) = {( \frac{{S}_{I} ( x ) - \sqrt{x}}{\sqrt{x}} )}^{2} .$$
